(19) United States
(12) Patent Application Publication
(10) Pub. No.: US 2026/0067667 A1
(43) Pub. Date: Mar. 5, 2026

(54) MITIGATING REPLAY ATTACKS DURING ROAMING WITH SHARED PTK

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US); Stephen M. ORR, Wallkill, NY (US)

(21) Appl. No.: 19/281,648

(22) Filed: Jul. 26, 2025

Related U.S. Application Data
(60) Provisional application No. 63/687,685, filed on Aug. 27, 2024.

(51) Int. Cl. H04W 8/08; H04W 12/037; H04W 12/0431; H04W 76/10

(52) U.S. Cl. CPC H04W 8/08; H04W 12/037; H04W 12/0431; H04W 76/10

(57) ABSTRACT

The present disclosure provides techniques for mitigating replay attacks during roaming with a shared pairwise transient key (PTK). A first access point (AP) receives a first roaming request from a station (STA), where the first roaming request comprises a first packet number (PN). In response to determining that the first PN is less than or equal to a last known PN maintained by the first AP, the first AP discards the roaming request.

### CROSS-REFERENCE TO RELATED APPLICATIONS

This application claims benefit of co-pending U.S. provisional patent application Ser. No. 63/687,685 filed Aug. 27, 2024. The aforementioned related patent application is herein incorporated by reference in its entirety.

### TECHNICAL FIELD

Embodiments presented in this disclosure generally relate to wireless communication. More specifically, embodiments disclosed herein relate to mitigating replay attacks during roaming with a shared pairwise transient key (PTK).

### BACKGROUND

IEEE 802.11 Ultra-high reliability (UHR)/11bn is working towards defining mechanisms for seamless roaming across multiple access points (APs) within a mobility domain to support latency-sensitive applications, such as autonomous mobile robots and industrial Internet-of-Things (IoT). Seamless roaming allows a non-AP multi-link device (MLD) to transition from one AP MLD to another without service interruption. However, the ability to roam directly to target APs introduces new security challenges, such as replay attacks, where an adversary captures and replays a previously valid roaming request. Such attacks may lead to unwanted roaming events, unnecessary context transfers across the backhaul, and denial-of-service (DoS) conditions due to repeated processing of stale requests.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of client roaming within a seamless mobility domain (SMD), according to some embodiments of the present disclosure.

FIG. 2 depicts an example of a replay attack during roaming in a shared PTK-based SMD, according to some embodiments of the present disclosure.

FIG. 3 depicts an example of replay detection using per-STA PN caching at a target AP MLD, according to some embodiments of the present disclosure.

FIG. 4 depicts an example of TSF-based replay detection, according to some embodiments of the present disclosure.

FIG. 5 depicts an example of replay detection using roaming request sequence numbers (RR SNs), according to some embodiments of the present disclosure.

FIG. 6 depicts an example of deferred PN-based replay detection, according to some embodiments of the present disclosure.

FIG. 7 depicts an example method for replay detection using a per-STA PN cache, according to some embodiments of the present disclosure.

FIG. 8 depicts an example method for TSF-based replay detection, according to some embodiments of the present disclosure.

FIG. 9 depicts an example method for replay detection using RR SNs, according to some embodiments of the present disclosure.

FIG. 10 depicts an example method for deferred PN-based replay detection, according to some embodiments of the present disclosure.

FIG. 11 is a block diagram depicting an example method for PN-based replay detection, according to some embodiments of the present disclosure.

FIG. 12 is a block diagram depicting an example method for TSF-based replay detection, according to some embodiments of the present disclosure.

FIG. 13 is a block diagram depicting an example method for RR SN-based replay detection, according to some embodiments of the present disclosure.

FIG. 14 is a block diagram depicting an example method for deferred PN-based replay detection, according to some embodiments of the present disclosure.

FIG. 15 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a first access point (AP), a first roaming request from a station (STA), where the first roaming request comprises a first packet number (PN), and in response to determining that the first PN is less than or equal to a last known PN maintained by the first AP, discarding the roaming request by the first AP.

One embodiment presented in this disclosure provides a method, including determining, by a first access point (AP), a threshold value based on one or more prior time synchronization function (TSF) values received from a station (STA), receiving, by the first AP, a roaming request from the STA, where the roaming request comprises an estimated TSF time of the first AP, comparing, by the first AP, the estimated TSF time with a current TSF time maintained by the first AP, and in response to determining that a difference between the estimated TSF time and the current TSF time exceeds the threshold value, discarding the roaming request by the first AP.

One embodiment presented in this disclosure provides a method, including receiving, by a first access point (AP), a first roaming request from a station (STA), where the roaming request comprises a first roaming request sequence number (RR SN) associated with the STA, comparing, by the first AP, the first RR SN with a last known RR SN associated with the STA, and in response to determining that the first RR SN is less than or equal to the last known RR SN, discarding the first roaming request by the first AP.

One embodiment presented in this disclosure provides a method, including receiving, by a first access point (AP), a first roaming request from a station (STA), where the first roaming request comprises a first PN, storing, by the first AP, the first PN in a cache and placing the first roaming request in a pending state, retrieving, by the first AP, one or more control-plane context parameters from a second AP associated with the STA, the control-plane context parameters comprising a packet number (PN), comparing the first PN with the retrieved PN, and in response to determining that the first PN is less than or equal to the retrieved PN, transitioning, by the first AP, the first roaming request from the pending state to a discarded state.

### EXAMPLE EMBODIMENTS

The IEEE 802.11 standard is moving towards defining seamless roaming across APs within a mobility domain. Seamless roaming allows a non-AP multi-link device (MLD) to shift from one AP MLD to another without experiencing service interruption. The capability is beneficial for applications requiring continuous connectivity, such as autonomous mobile robots (AMRs), voice over wireless local area network (WLAN), and other latency-sensitive use cases.

There are two general approaches being considered for enabling seamless roaming. In the first approach, also referred to as the shared PTK architecture, a common PTK is used across multiple non-collocated AP MLDs within a single or seamless mobility domain (SMD). The shared-key model allows a non-AP MLD to securely roam between AP MLDs using the same security context. This approach simplifies key management and improves scalability, making it particularly suitable for enterprise deployments. The second approach involves using a different PTK per AP MLD, similar to the fast transition (FT) method. In both architectures, roaming is initiated by the non-AP MLD STA when certain triggers are met, such as a drop in signal strength or loss of connectivity with the serving AP MLD.

In the shared PTK architecture, the non-AP MLD STA may directly send a protected management frame (PMF)-protected roaming request to a target AP MLD within the SMD. The request is encrypted using the shared PTK, which the target AP may already have cached (e.g., from a roaming preparation phase) or can retrieve from the current serving AP MLD. Upon receiving and decrypting the roaming request, the target AP fetches necessary context from the serving AP MLD to ensure continuous communication without interruption. The context may include sequence numbers (SNs), packet numbers (PNs), and block acknowledgement (BA) state, as well as other control-plane elements such as stream classification service (SCS) and target wake time (TWT) parameters.

A security challenge arises during this process. The target AP MLD does not inherently know whether the roaming request is fresh or a replay of a previously valid request. An adversary can exploit the ambiguity in request liveness by intercepting a legitimate roaming request from the non-AP MLD and replaying it later to the same or another AP MLD. If the target AP cannot detect the replay, the AP may incorrectly initiate context transfer and roaming procedures based on a stale or maliciously repeated request. The replay attack may also result in unnecessary local area network (LAN)/wide area network (WAN) or backhaul traffic, unintended roaming behavior, and denial-of-service (DoS) conditions due to excessive control-plane operations and resource usage.

The present disclosure provides systems, methods, and apparatuses that enable the target AP MLD to perform replay detection when receiving a roaming request from a non-AP MLD. The disclosed techniques allow the target AP to assess the validity of the received request and reject replayed or outdated messages before initiating any context transfer or roaming procedures.

As used herein, the term “roaming request” is intended to generically refer to any frame that indicates intent to roam. This may include, for example, a roaming link configuration request that indicates a new link is to be added (or to be deleted), or any other type of frame used to signal the intent to roam to a different AP MLD within the mobility domain.

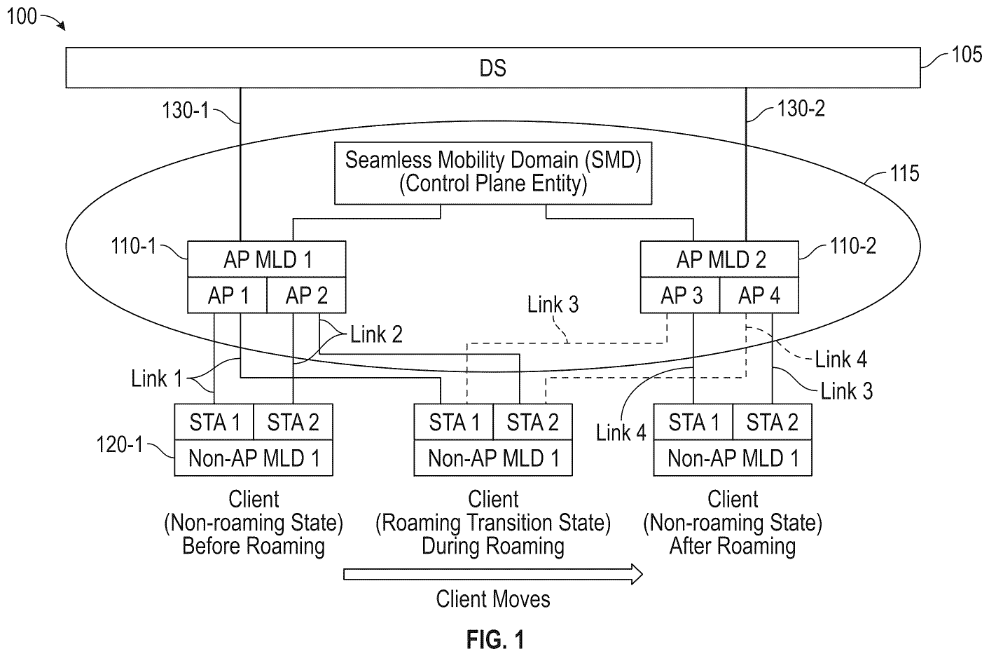

FIG. 1 depicts an example 100 of client roaming within a seamless mobility domain (SMD), according to some embodiments of the present disclosure.

In this example 100, two access point multi-link devices (AP MLDs) 110-1 and 110-2 are provided, each including two affiliated AP radios. Specifically, AP MLD 1 includes AP 1 and AP 2, and AP MLD 2 includes AP 3 and AP 4. Both AP 110-1 and 110-2 are part of the same seamless mobility domain (SMD) 115.

As used herein, a SMD refers to a logical control plane entity that enables seamless client roaming across multiple AP MLDs. One SMD may include all AP MLDs in an extended service set (ESS), or an ESS may be partitioned into multiple SMDs depending on network configuration and mobility policies. Each SMD is uniquely identified within the network by a virtual SMD media access control (MAC) address, and each AP MLD is statically configured with the SMD to which it belongs. Affiliated APs (e.g., AP 1 or AP 2) of each AP MLD advertise the associated SMD information in management frames such as beacons and probe responses. Each AP MLD maintains its own MAC service access point (MAC SAP) interface to the distribution system (DS). As depicted, AP MLD 1 (110-1) connects to the DS 105 through MAC SAP 1 (130-1), and AP MLD 2 (110-2) connects to the DS 105 through MAC SAP 2 (130-2).

As depicted, the client device is a non-AP MLD 120-1, also referred to in some embodiments as a station multi-link device (STA MLD), which includes two affiliated radios, STA 1 and STA 2. To initiate communication within the SMD 115, the STA MLD 120-1 performs authentication and association procedures with AP MLD 1 (110-1) and therefore establishes two initial links: Link 1 and Link 2. As depicted, Link 1 connects STA 1 to AP 1, and Link 2 connects STA 2 to AP 2. The SMD 115 maintains the control plan state for the client 120-1, including association information, security context, and capability parameters.

During roaming, the non-AP MLD 120-1 establishes new links with the target AP MLD 2 (110-2), forming Link 3 that connects STA 1 to AP 3 and Link 4 that connects STA 2 to AP 4. The intermediate state enables the client to maintain simultaneous connectivity with both the serving and target AP MLDs and achieves make-before-break roaming. More specifically, the non-AP MLD 120-1 maintains downlink (DL) wireless connectivity with both AP MLDs 110 to receive any buffered DL data from the serving AP MLD 110-1. For uplink (UL) traffic, the non-AP MLD 120-1 maintains connectivity with only one AP MLD 110 at a time, first with the source AP MLD 110-1 and then with the target AP MLD 110-2 after reassociation is completed.

Once the transition is complete, the non-AP MLD 120-1 disassociates from AP MLD 110-1 and removes Link 1 and Link 2. The non-AP MLD 120-1 maintains Link 3 and Link 4 for ongoing communication through AP MLD 2 (110-2). Through the roaming process, the non-AP MLD 120-1 may initiate a roaming request to the target AP MLD 110-2 to trigger the reassociation and context transfer.

In the shared PTK architecture, the roaming request is protected using PMF and encrypted with the shared PTK, which is common across all AP MLDs (including AP MLD 1 and AP MLD 2) within the same SMD. The target AP MLD 110-2 may already have the PTK cached from prior roaming preparation, or it may retrieve the key from the serving AP MLD 110-1 prior to processing. Once decrypted, the roaming request prompts the target AP MLD 110-1 to fetch context (e.g., SN, PN, BA state, or other control-plane information like SCS or TWT) to preserve session continuity for the client device.

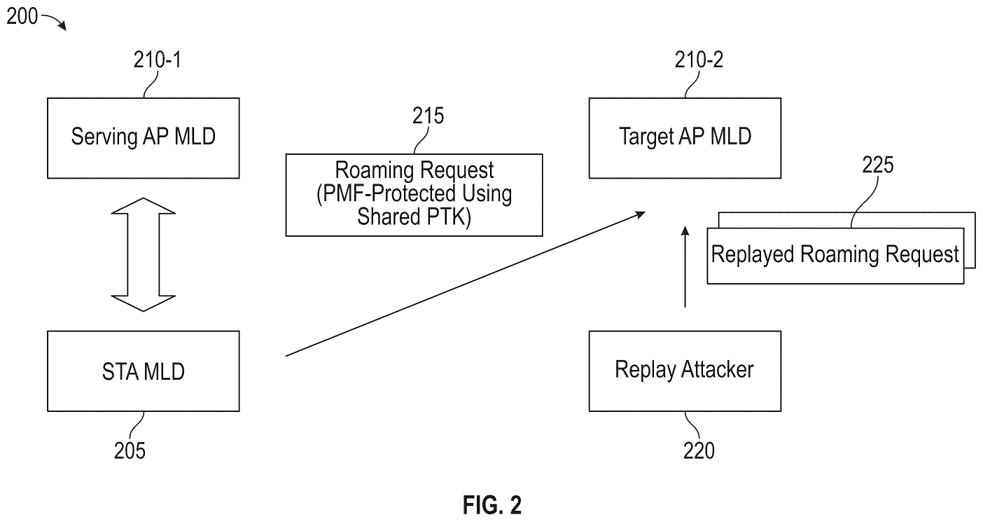

However, due to the use of a shared PTK across the SMD, the target AP MLD lacks inherent mechanisms to verify the validity (or freshness) of the roaming request. As a result, the system becomes vulnerable to replay attacks, where an attacker may intercept a valid roaming request from the client and resend it to the target AP at a later time. To mitigate the risk, the present disclosure introduces a set of replay detection mechanisms that enable the target AP MLD 110-2 to assess whether an incoming roaming request is fresh or replayed. These mechanisms allow the AP MLD to safely reject stale or malicious roaming frames prior to initiating any control-plane operations. More details about the replay attack are discussed below with reference to FIG. 2.

FIG. 2 depicts an example 200 of a roaming replay attack scenario within a SMD using a shared PTK, according to some embodiments of the present disclosure.

In the depicted example 200, a STA MLD 205 is initially associated with the serving AP MLD 210-1. When the STA MLD 205 determines that a roam is needed (e.g., due to degraded link quality), the STA MLD 205 initiates a roaming procedure by transmitting a roaming request 215 to the target AP MLD 210-2. The roaming request 215 is protected using PMF and is encrypted with a shared PTK. The shared PTK may be established between the STA MLD 205 and serving AP MLD 210-1 and shared with the target AP MLD via management frames.

The target AP MLD 210-2, upon receiving the roaming request, decrypts the frame and may proceed to fetch context from the serving AP MLD 210-1 to support seamless handover.

In this example, a replay attacker 220 is positioned to intercept the original roaming request 215 transmitted by the STA MLD 205. After capturing the valid request, the attacker 220 stores and retransmits one or more copies 225 of the same roaming request to the target AP MLD 210-2 at a later time. These retransmissions, referred to as replayed roaming requests 225, may occur at different time intervals and may appear valid to the target AP MLD due to the integrity of the PMF protection and the shared PTK encryption.

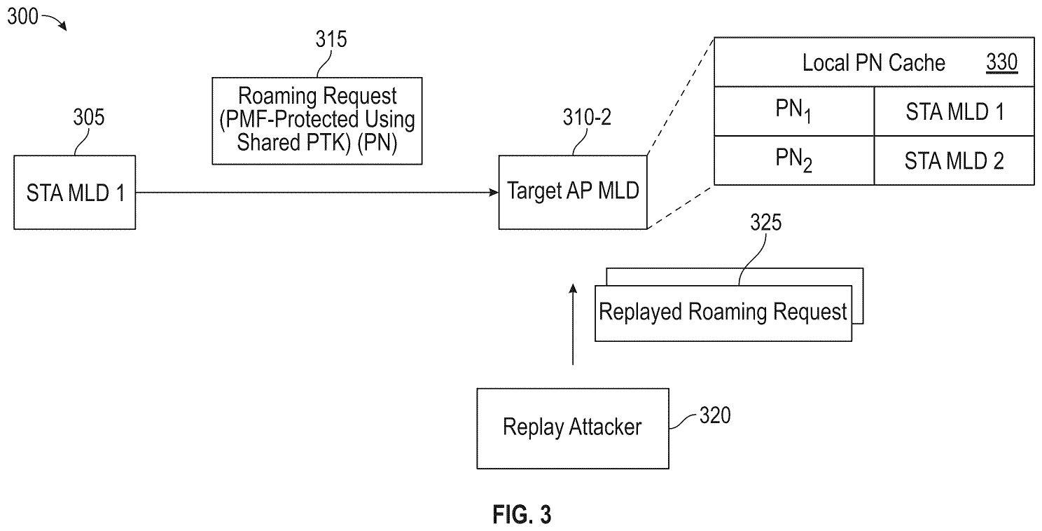

If the target AP MLD 210-1 is unable to distinguish between a fresh roaming request and a replayed one, it may unnecessarily trigger context transfer from the serving AP MLD 210-1 or cause the STA MLD 205 to roam again, even when such roaming is not desired or initiated by the client. This may result in unwanted roaming behavior, excessive backhaul signaling, and possible DoS conditions. As discussed in more detail below with references to FIGS. 3-6, the present disclosure provides multiple mechanisms to enable the target AP MLD 210-2 to perform replay detection and reject stale or malicious roaming requests.

FIG. 3 depicts an example 300 of replay detection using per-STA PN caching at a target AP MLD, according to some embodiments of the present disclosure.

As depicted, the STA MLD 305 initiates a roaming operation by sending a PMF-protected roaming request 315 to the target AP MLD 310-2. The roaming request is encrypted using a PTK shared to all AP MLDs within the SMD. Upon reception, the target AP MLD 310-2 decrypts the roaming request and, as part of the process, obtains the PN from the cryptographic header of the frame.

As shown, the target AP MLD 310-2 maintains a local PN cache 330, which records the last valid PN received from each known STA MLD. As illustrated, PN₁ is saved for STA MLD 1 (305), and PN₂ is for STA MLD 2 (not shown in this figure). When receiving a new roaming request allegedly from STA MLD 305, the target AP MLD 310-2 extracts the PN from the decrypted request and compares it against the cached PN value (PN₁) associated with STA MLD 305. If the received PN is greater than PN₁, the roaming request is considered valid, and the AP proceeds with further processing (e.g., sending a roaming response back to the STA 305). The PN cache is then updated with the newly received PN. However, if the received PN is less than or equal to the PN₁, the roaming request is classified as a replayed frame 325 (e.g., potentially from a replay attacker 320), and is discarded without initiating context transfer or reassociation procedure.

The illustrated mechanism allows each target AP MLD to perform independent and per-STA replay detection and avoid the overhead and latency of contacting the serving AP MLD. The PN is extracted directly from the PMF-protected roaming request. Therefore, the solution is lightweight and cryptographically effective.

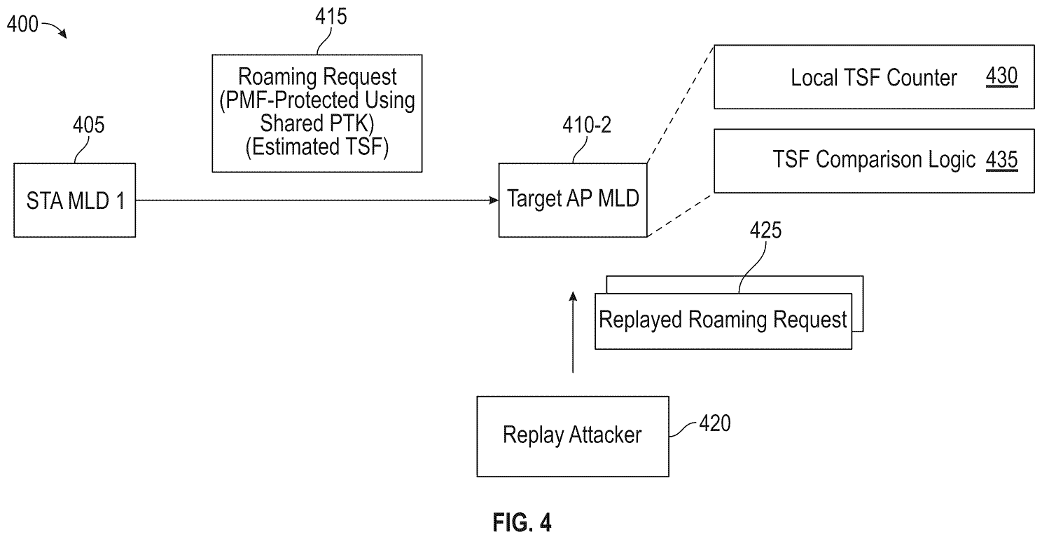

FIG. 4 depicts an example 400 of TSF-based replay detection, according to some embodiments of the present disclosure.

In the depicted example 400, the STA MLD 405 is preparing to roam to the target AP MLD 410-2. Prior to initiating the roaming, the STA MLD 405 obtains neighbor timing information about the target AP MLD from reduced neighbor reports (RNRs), such as from the target beacon transmission time (TBTT) offset field included in those reports. In some embodiments, the RNR may be sent via a beacon frame broadcast by the target AP or a probe response frame sent by the target AP in response to a probe request from the STA. Using the offset, along with its local TSF reference, the STA MLD 405 estimates the current TSF value of the target AP MLD. The estimated TSF time is then included as a field in PMF-protected roaming request 415, which is transmitted to the target AP MLD 410-2. The estimated TSF value may be represented in time units (TUs) or other units of granularity.

Upon receiving the roaming request 415, the target AP MLD 410-2 decrypts the frame using the shared PTK and extracts the TSF estimate. The target AP MLD 410-1 includes a local TSF counter 430, which maintains the AP's current TSF value, as well as a TSF comparison logic 435, which is configured to evaluate the validity (or liveness) of incoming roaming requests. The extracted STA-estimated TSF (e.g., TSF_Estimated) is compared against the current local TSF counter (e.g., (TSF_Local) to determine the time delta between the two values. If the difference between the estimated TSF and the local TSF is within a defined threshold, the request is considered valid (or fresh), and the target AP proceeds with further roaming operations, such as context fetch from the serving AP MLD. If the time delta exceeds the threshold, the roaming request is assumed to be stale or replayed, and is discarded without triggering further processing. The decision-making logic accounts for the fact that a replayed request 425 is a copy of a previously intercepted message, and therefore the embedded TSF estimate lags significantly behind the target AP's current TSF, indicating that the request is no longer timely or valid.

In some embodiments, the threshold for TSF comparison may be determined based on various parameters, including previously observed TSF offsets for that STA MLD, beacon interval characteristics, or a preconfigured system constant designed to tolerate network jitter or propagating delay. In some embodiments, the threshold may be dynamically tuned based on historical timing behavior associated with the STA MLD timing tolerances. The disclosed mechanism enables a lightweight liveness check that allows the target AP MLD to detect and discard replayed roaming requests without invoking additional signaling or state transfer.

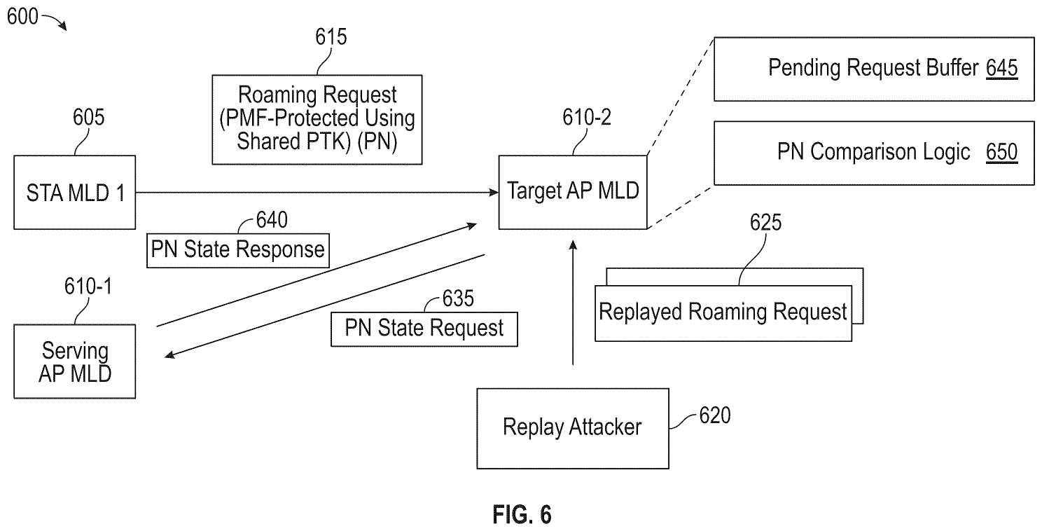

In some embodiments, additional validation steps may be performed after determining that the time delta falls within the threshold. For example, in some embodiments, a PN-based replay detection may be performed following TSF validation (discussed below with reference to FIG. 6). In such configurations, the target AP MLD 410-2 obtains the PN state from the serving AP MLD (which is identified in the roaming request) and performs PN comparison to confirm the request has not been replayed at the cryptographic level. If the PN check passes, the target AP MLD may then proceed to fetch the full control plane context from the serving AP MLD, including SN, BA state, SCS, and TWT agreements, to complete the roaming process. If the PN check fails, the target AP MLD discards the roaming request without proceeding further.

The estimated TSF time may be encoded as a field in an existing information element or included in a new element within the roaming request.

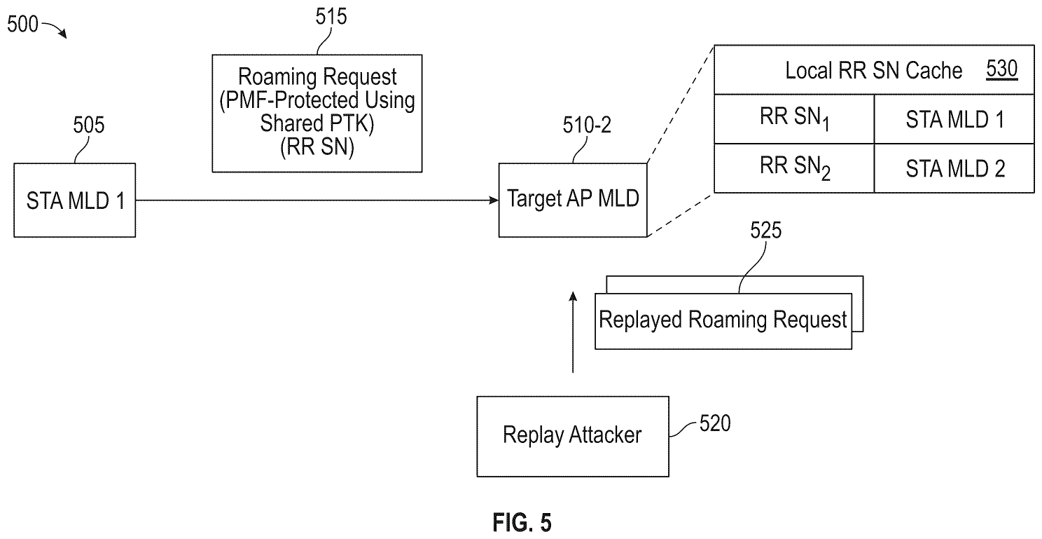

FIG. 5 depicts an example 500 of replay detection using roaming request sequence numbers (RR SNs), according to some embodiments of the present disclosure.

In the example 500, STA MLD 1 (505) initiates a roaming operation by transmitting a roaming request 515 to the target AP MLD 510-2. The roaming request is protected using PMF and includes an RR SN. As used herein, the RR SN refers to a monotonically increasing counter maintained by each non-AP MLD (e.g., STA MLD 1) to uniquely identify each roaming attempt within a SMD. The RR SN value is incremented by the STA MLD for each new roaming request it initiates. Each AP MLD within the SMD maintains a local RR SN cache 530 to store the most recently accepted RR SN for each associated STA MLD. The target AP may use the stored information to determine whether an incoming request carries a new, equal, or older SN. In the illustrated example 500, the request from STA MLD 1 carries RR SN=1. After processing the roaming request 515, the target AP MLD 510-2 updates the cache 530 to reflect the RR SN associated with STA MLD 1. As shown, the cache 530 stores RR SN₁ (e.g., RR SN₁=1) for STA MLD 1 (505) and RR SN₂ for STA MLD 2 (not shown in this figure).

In a subsequent attack scenario, a replay attacker 520 intercepts the original roaming request 515 and sends one or more replayed roaming requests 525 to the target AP MLD 510-2. The replayed request also carries RR SN=1, which is identical to the previously accepted request. In some embodiments, the replayed request may be sent after the STA MLD 1 has already issued a newer roaming request to the target AP MLD 510-2 carrying RR SN=2. In this configuration, the cached RR SN value for STA MLD 1 has already been updated to RR SN₁=2. As a result, the replayed request still carrying RR SN=1 is lower than the cached RR SN value for STA MLD 1.

Upon receiving the replayed request, the target AP MLD 510-2 compares the RR SN in the incoming request against the cached RR SN for STA MLD 1 and detects that the received value is equal to or less than the stored value. Following that, the target AP MLD identifies the request as a replay frame and discards it without performing any context transfer or handover operations.

If the received RR SN is larger than the cached RR SN, the target AP MLD 510-2 considers the roaming request to be new and not replayed. In this configuration, the target AP MLD 510-2 may then proceed with validating the request and fetching the control plane context (e.g., SN, PN, BA state, SCS, and TWT agreements) from the serving AP MLD. The RR SN cache 530 is subsequently updated with the new RR SN to support future replay detection.

The disclosed approach enables each AP MLD within the SMD to perform per-STA replay detection using lightweight sequence number tracking, without relying on timing information or cryptographic validation. The RR SN cache 530 may be maintained locally by each AP MLD and, in some embodiments, may be synchronized across AP MLDs in the SMD once a roaming event is successfully completed. Such synchronization may be event-driven (e.g., triggered by a completed roam) or performed periodically in batches.

In some embodiments, after completing the RR SN verification (e.g., the received RR SN being larger than the cached RR SN), the target AP MLD 510-2 may then perform a PN-based replay detection (discussed below with reference to FIG. 6). Specifically, the target AP MLD 510-2 may retrieve the PN state from the serving AP MLD (as indicated in the roaming request) and compare it against the PN extracted from the current frame. If the PN check also passes, the target AP concludes that the request is valid and proceeds to fetch the full control plane context from the serving AP MLD. If either the RR SN or PN check fails, the roaming request is classified as stale or replayed and is discarded without initiating context transfer.

FIG. 6 depicts an example 600 of deferred PN-based replay detection, according to some embodiments of the present disclosure.

In this example 600, STA MLD 1 (605) initiates a roam by sending a roaming request 615 to the target AP MLD 610-2. The request is PMF-protected using the shared PTK and includes a PN value included within the encrypted frame header. Upon receiving the request, the target AP MLD 610-2 does not immediately process or validate the roaming request. Instead, the frame is temporarily stored in a pending request buffer 645, and the AP initiates a PN state request 635 to the serving AP MLD 610-1.

The serving AP MLD 610-1 responds with a PN state response 640, which provides the last known PN value associated with STA MLD 1 (605). The target AP MLD 610-2 then invokes its internal PN comparison logic 650 to evaluate whether the PN extracted from the decrypted roaming request 615 is greater than the PN from the serving AP. If the PN check passes, the target AP MLD 610-2 proceeds with fetching the full control plane context from the serving AP MLD, including SN, BA state, SCS, TWT agreements, and other association-related information. However, if the PN check fails (e.g., the received PN is less than or equal to the previously recorded PN), the target AP identifies the roaming request as replayed 625 and discards it without initiating any context transfer.

As depicted, a replay attacker 620 intercepts the original roaming request 615 and later transmits one or more replay roaming requests 625 to the target AP MLD 610-2. The replayed request includes the same PN as the original, but is sent at a later time, after the serving AP's PN state has advanced. As a result, when the target AP MLD 610-2 retrieves the current PN state from the serving AP and compares it against the replayed request, the comparison logic 650 detects that the request is stale, and the target AP discards it accordingly.

The disclosed approach provides a reliable replay detection mechanism by deferring context transfer until after cryptographic liveness (or freshness) is verified. This mechanism avoids unnecessary signaling, resource allocation, or reassociation in response to replayed roaming attempts. The disclosed approach also preserves compatibility with PMF and shared PTK roaming architectures.

In some embodiments, the implementation disclosed and depicted in any of FIGS. 3-6 may be combined in any manner with one another.

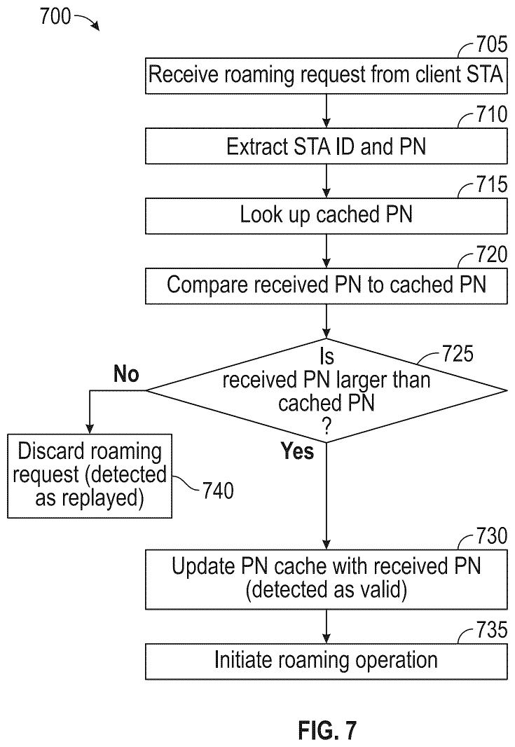

FIG. 7 depicts an example method 700 for replay detection using a per-STA PN cache, according to some embodiments of the present disclosure.

The example method 700 may be performed by a target AP, such as AP MLD 2 (110-2) as depicted in FIG. 1, AP MLD 210-2 as depicted in FIG. 2, or AP MLD 310-2 as depicted in FIG. 3. In some embodiments, the example method 700 may be performed by any network device configured to manage roaming, such as a router, wireless controller, or cloud-based mobility service.

At block 705, a target AP MLD (e.g., AP MLD 310-1 of FIG. 3) receives a roaming request from a client device (e.g., STA MLD 305 of FIG. 3). The roaming request is PMF-protected and encrypted using a shared PTK known across APs within the same mobility domain.

At block 710, the target AP MLD decrypts the roaming request and extracts the STA identifier (ID) (e.g., MAC address of the STA) and the PN from the decrypted frame. The PN value may be included in the header of the PMF-protected frame and used to detect replayed transmissions.

At block 715, the AP looks up the cached PN value associated with the identified STA in its local per-STA PN cache (e.g., 330 of FIG. 3). The cache maintains the most recently accepted PN for each STA that has previously roamed through or communicated with the AP.

At block 720, the target AP compares the received PN from the current roaming request against the cached PN. At block 725, the AP determines whether the received PN is greater than the cached PN. If the received PN is greater, the request is considered fresh and non-replayed. The method 700 then proceeds to block 730.

At block 730, the AP classifies the request as valid (or fresh), and updates the PN cache with the newly received PN to reflect the latest valid request for the STA. At block 735, the AP initiates the roaming operation by sending a roaming response back to the STA (e.g., approving the request) and begins to retrieve the control plane context from the serving AP MLD. The context may include SN, BA state, SCS, TWT agreements, and any other association-related information for seamless transition. In some embodiments, the target AP may also retrieve the PN state from the serving AP MLD to perform an additional PN-based replay check, which provides a second layer of verification before proceeding with full context transfer.

If, at block 725, the received PN is less than or equal to the cached PN, the method 700 proceeds to block 740. In this configuration, the AP determines that the roaming request is a replayed or stale request (e.g., a retransmission of a previously intercepted frame by an attacker). The AP then discards the request without performing any further processing or initiating context transfer.

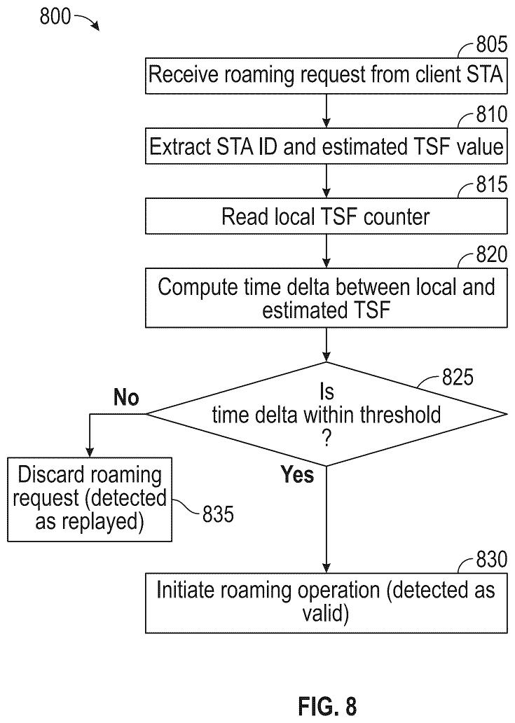

FIG. 8 depicts an example method 800 for TSF-based replay detection, according to some embodiments of the present disclosure.

The example method 800 may be performed by a target AP, such as AP MLD 2 (110-2) as depicted in FIG. 1, AP MLD 210-2 as depicted in FIG. 2, or AP MLD 410-2 as depicted in FIG. 4. In some embodiments, the example method 800 may be performed by any network device configured to manage roaming, such as a router, wireless controller, or cloud-based mobility service.

At block 805, a target AP MLD (e.g., AP MLD 410-2 of FIG. 4) receives a roaming request from a client device (e.g., STA MLD 405 of FIG. 3). The roaming request is PMF-protected and encrypted using a shared PTK known across APs within the same mobility domain.

At block 810, the target AP MLD decrypts the request to extract the STA ID and the estimated TSF time that was computed and inserted by the STA MLD. The TSF value reflects the STA's estimate of the target AP's TSF at the time of request generation. In some embodiments, the STA may estimate the TSF based on information obtained from a RNR.

At block 815, the target AP retrieves its current TSF value from its local TSF counter. The local TSF value is then compared with the estimated TSF received from the STA.

At block 820, the target AP calculates the difference (delta) between the estimated TSF from the STA and the current local TSF. At block 825, the AP checks whether the computed delta is within a defined threshold. The threshold may be determined based on historical STA behavior, expected propagation delay, beacon intervals, or static configuration.

If, at block 825, the time delta is within the acceptable threshold, the request is considered fresh and valid. The method 800 proceeds to block 830, where the AP initiates the roaming operation by sending a roaming response back to the STA (e.g., approving the request), and begins to retrieve the control plane context from the serving AP MLD. In some embodiments, following the determination that the time delta is within the acceptable threshold, the AP may request the real-time PN state from the serving AP and perform an additional cryptographic replay check using PN comparison. Once the PN-based check is passed, the AP proceeds to fetch the full control plane context from the serving AP. If the PN-based check fails, the AP discards the request without performing a full context transfer.

If, at block 825, the time delta exceeds the defined threshold, the method 800 moves to block 835, where the AP concludes the request is likely replayed and discards it without performing context transfer.

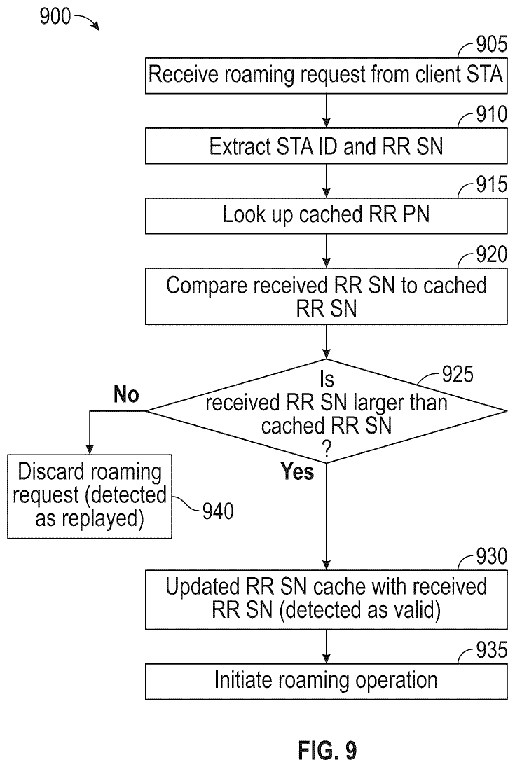

FIG. 9 depicts an example method 900 for replay detection using RR SNs, according to some embodiments of the present disclosure.

The example method 900 may be performed by a target AP, such as AP MLD 2 (110-2) as depicted in FIG. 1, AP MLD 210-2 as depicted in FIG. 2, or AP MLD 510-2 as depicted in FIG. 5. In some embodiments, the example method 900 may be performed by any network device configured to manage roaming, such as a router, wireless controller, or cloud-based mobility service.

At block 905, a target AP MLD (e.g., 510-2 of FIG. 5) receives a roaming request from a non-AP MLD (e.g., 505 of FIG. 5). The request is PMF-protected and encrypted using a shared PTK.

At block 910, the target AP MLD decrypts the received roaming request using the shared PTK. After decryption, the target AP extracts the STA ID (e.g., MAC address or unique client ID) and the RR SN included in the request by the STA.

At block 915, the target AP MLD retrieves the most recently accepted RR SN for the identified STA from its local RR SN cache (e.g., 530 of FIG. 5).

At block 920, the target AP MLD compares the received RR SN to the stored RR SN for the STA. At block 925, the AP determines whether the received RR SN is greater than the cached value. If the received RR SN is greater than the cached value, the method 900 proceeds to block 930, where the AP updates the cache with the new RR SN and classifies the request as valid.

At block 935, the AP initiates roaming by fetching control plane state (e.g., SN, PN, BA, TWT, SCS) from the serving AP and/or sending a roaming acceptance response back to the STA.

If, at block 925, the received RR SN is less than or equal to the cached RR SN, the method 900 moves to block 940, where the AP concludes the request is a replay or duplicate. The AP discards the request without triggering a context transfer.

In some embodiments, after a roaming request passes the RR SN comparison (e.g., the received RR SN is greater than the cached value), the target AP MLD may perform an additional replay verification step based on the PN. Specifically, the target AP MLD may request the current PN state associated with the STA from the serving AP MLD. Upon receiving the PN value, the target AP decrypts the roaming request (if not already decrypted), extracts the PN from the frame header, and compares it against the PN state retrieved from the serving AP. If the received PN is greater than the PN provided by the serving AP, the request is considered fresh and processing may continue (e.g., retrieving the full control plane state). If the PN is less than or equal to the provided value, the request is classified as a replay frame and discarded. The dual-layer replay detection provides improved protection against replay attacks.

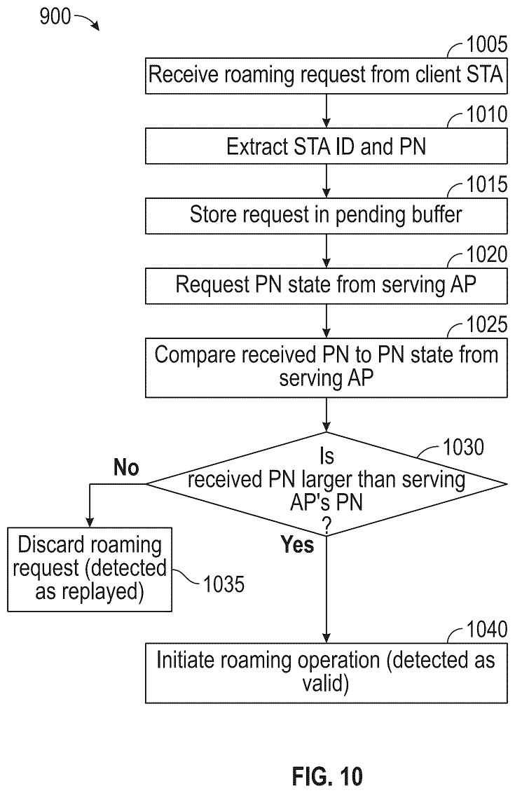

FIG. 10 depicts an example method 1000 for deferred PN-based replay detection, according to some embodiments of the present disclosure.

The example method 1000 may be performed by a target AP, such as AP MLD 2 (110-2) as depicted in FIG. 1, AP MLD 210-2 as depicted in FIG. 2, or AP MLD 610-2 as depicted in FIG. 6. In some embodiments, the example method 1000 may be performed by any network device configured to manage roaming, such as a router, wireless controller, or cloud-based mobility service.

The example method enables the target AP MLD to postpone roaming-related context transfer and reassociation until the liveness (or freshness) of the roaming request can be verified using PN state retrieved from the serving AP MLD.

At block 1005, a target AP MLD (e.g., AP MLD 610-2 of FIG. 6) receives a PMF-protected roaming request from a client STA MLD (e.g., STA MLD 605 of FIG. 6). The frame is encrypted using a shared PTK within a SMD.

At block 1010, the target AP MLD decrypts the frame and extracts the STA ID (e.g., MAC address or unique client ID) and PN from the protected header.

At block 1015, instead of immediately processing the request, the AP stores the roaming request in a pending buffer (e.g., 645 of FIG. 6). The deferral ensures that no context transfer or reassociation occurs before liveness (or freshness) is validated.

At block 1020, the target AP MLD sends a PN state request to the serving AP MLD (e.g., AP MLD 610-1 of FIG. 6) for the STA. The serving AP is identified based on information in the roaming request. The PN state request may be sent using a management frame defined for inter-AP coordination.

At block 1025, the target AP MLD receives a PN state response from the serving AP MLD. The response includes the last known valid PN value associated with the roaming STA. The PN value indicates the most recent frame processed by the serving AP under the shared PTK context. The target AP MLD retrieves the stored roaming request from its pending buffer and compares the PN extracted from the request with the PN value received from the serving AP. The comparison is used to determine whether the roaming request is fresh (e.g., not previously used or replayed).

At block 1030, the target AP determines whether the received PN is larger than the serving AP's PN. If the received PN is larger, the AP classifies the request as valid. The method proceeds to block 1040, where the AP initiates roaming by fetching full plane context from the serving AP (e.g., SN, BA, TWT, and SCS). The STA is reassociated as part of the seamless roaming process.

If, at block 1030, the PN is less than or equal to the serving AP's PN, the method 1000 moves to block 1035, where the target AP classifies the request as replayed and discards it without initiating any context transfer or reassociation.

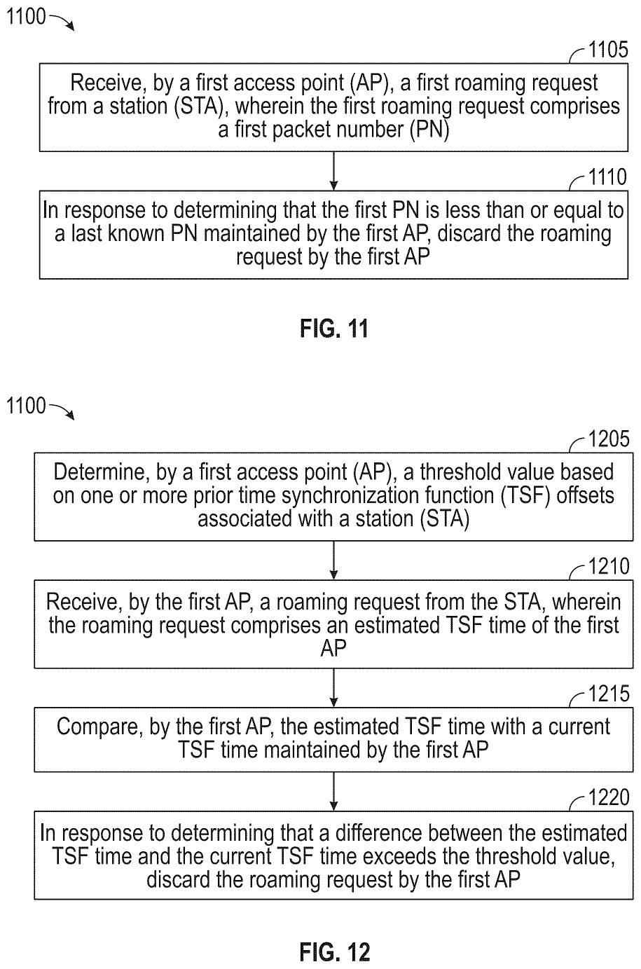

FIG. 11 is a block diagram depicting an example method 1100 for PN-based replay detection, according to some embodiments of the present disclosure.

At block 1105, a first AP (e.g., 310-2 of FIG. 3) receives a first roaming request from a station (STA) (e.g., STA MLD 305 of FIG. 3), where the first roaming request comprises a first packet number (PN).

At block 1110, in response to determining that the first PN is less than or equal to a last known PN maintained by the first AP, the first AP discards the roaming request.

In some embodiments, the last known PN (e.g., PN₁ as depicted in FIG. 3) may be determined by the first AP based on a prior roaming request successfully received and processed from the STA by the first AP.

In some embodiments, the last known PN may be received from a second AP (e.g., AP MLD 610-1 of FIG. 6), where the first and second APs are within a same seamless mobility domain (SMD).

In some embodiments, the first roaming request may be protected by a shared pairwise transient key (PTK) that is shared between the first AP and the second AP.

In some embodiments, the first AP may receive a second roaming request from the STA, where the second roaming request comprises a second PN. In response to determining that the second PN is greater than the last known PN, the first AP may send a roaming response to the STA to establish a connection.

In some embodiments, the first AP may update the last known PN associated with the STA to reflect the second PN.

FIG. 12 is a block diagram depicting an example method 1200 for TSF-based replay detection, according to some embodiments of the present disclosure.

At block 1205, a first AP (e.g., AP MLD 410-2 of FIG. 4) determines a threshold value based on one or more prior time synchronization function (TSF) offsets associated with a station (STA) (e.g., STA MLD 405 of FIG. 4).

At block 1210, the first AP receives a roaming request from the STA, where the roaming request comprises an estimated TSF time of the first AP.

At block 1215, the first AP compares the estimated TSF time with a current TSF time maintained by the first AP.

At block 1220, in response to determining that a difference between the estimated TSF time and the current TSF time exceeds the threshold value, the first AP discards the roaming request.

In some embodiments, the roaming request may be protected by a shared pairwise transient key (PTK) that is shared between the first AP and a second AP, and the first and second APs are within a same seamless mobility domain (SMD).

In some embodiments, the first AP may receive a second roaming request from the STA, where the second roaming request comprises a second estimated TSF time of the first AP. The first AP compares the second estimated TSF time with the current TSF time maintained by the first AP.

In some embodiments, in response to determining that a difference between the second estimated TSF time and the current TSF time is within the threshold value, the first AP may send a roaming response to the STA to establish a connection.

In some embodiments, in response to determining that a difference between the second estimated TSF time and the current TSF time is within the threshold value, the first AP may retrieve one or more control-plane context parameters from a second AP associated with the STA, the control-plane context parameters comprising a packet number (PN). The first AP may compare a PN within the second roaming request with the retrieved PN. In response to determining that the PN within the second roaming request is greater than the retrieved PN, the first AP may send a roaming response to the STA to establish a connection.

In some embodiments, in response to determining that a difference between the second estimated TSF time and the current TSF time is within the threshold value, the first AP may retrieve one or more control-plane context parameters from a second AP associated with the STA, the control-plane context parameters comprising a packet number (PN). The first AP may compare a PN within the second roaming request with the retrieved PN. In response to determining that the PN within the second roaming request is less than or equal to the retrieved PN, the first AP may discard the second roaming request by the first AP.

In some embodiments, the estimated TSF time of the first AP may be determined by the STA based on a target beacon transmission time (TBTT) offset received in a reduced neighbor report (RNR) element.

In some embodiments, the RNR element may be encapsulated within a beacon frame broadcast by the first AP or within a probe response frame sent by the first AP in response to a probe request from the STA.

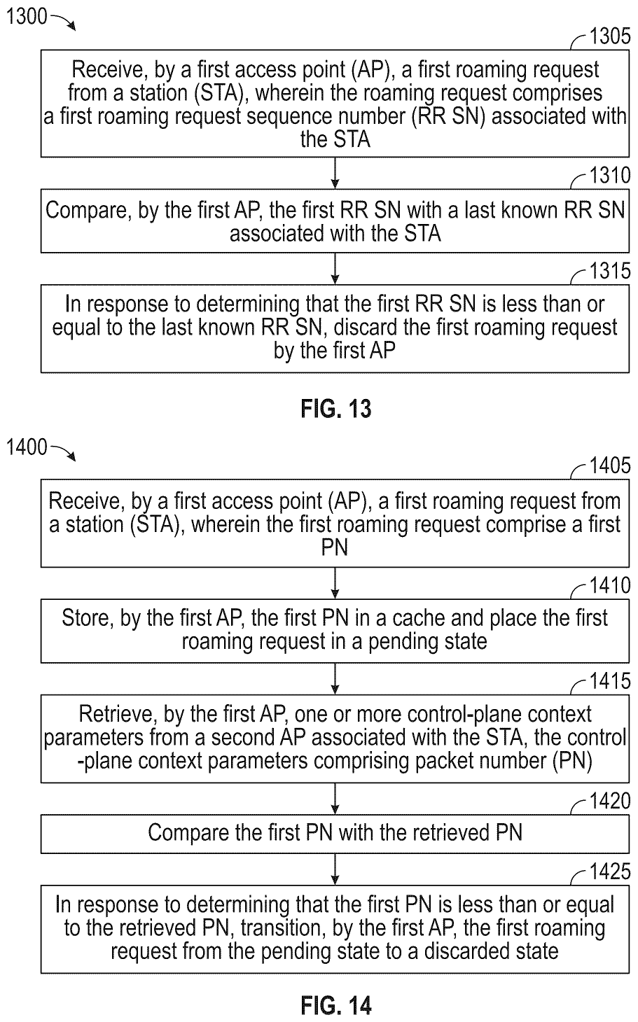

FIG. 13 is a block diagram depicting an example method 1300 for RR SN-based replay detection, according to some embodiments of the present disclosure.

At block 1305, a first AP (e.g., AP MLD 510-2 of FIG. 5) receives a first roaming request from a station (STA) (e.g., STA MLD 505 of FIG. 5), where the roaming request comprises a first roaming request sequence number (RR SN) associated with the STA.

At block 1310, the first AP compares the first RR SN with a last known RR SN associated with the STA.

At block 1315, in response to determining that the first RR SN is less than or equal to the last known RR SN, the first AP discards the first roaming request.

In some embodiments, the last known RR SN may be determined by the first AP based on a prior roaming request successfully received and processed from the STA by the first AP.

In some embodiments, the last known RR SN may be received from a second AP, where the first and second APs are within a same seamless mobility domain (SMD).

In some embodiments, the first roaming request may be protected by a shared pairwise transient key (PTK) that is shared between the first AP and the second AP.

In some embodiments, the first AP may receive a second roaming request from the STA, where the second roaming request comprises a second RR SN. The first AP may compare the second RR SN with the last known RR SN.

In some embodiments, in response to determining that the second RR SN is greater than the last known RR SN, the first AP may send a roaming response to the STA to establish a connection.

In some embodiments, in response to determining that the second RR SN is greater than the last known RR SN, the first AP may retrieve one or more control-plane context parameters from a second AP associated with the STA, the control-plane context parameters comprising a packet number (PN). The first AP may compare a PN within the second roaming request with the retrieved PN. In response to determining that the PN within the second roaming request is greater than the retrieved PN, the first AP may send a roaming response to the STA to establish a connection.

In some embodiments, in response to determining that the second RR SN is greater than the last known RR SN, the first AP may retrieve one or more control-plane context parameters from a second AP associated with the STA, the control-plane context parameters comprising a packet number (PN). The first AP may compare a PN within the second roaming request with the retrieved PN. In response to determining that the PN within the second roaming request is less than or equal to the retrieved PN, the first AP may discard the second roaming request by the first AP.

FIG. 14 is a block diagram depicting an example method 1400 for deferred PN-based replay detection, according to some embodiments of the present disclosure.

At block 1405, a first AP (e.g., AP MLD 610-2 of FIG. 6) receives a first roaming request from a station (STA) (e.g., STA MLD 605 of FIG. 6), where the first roaming request comprises a first PN.

At block 1410, the first AP stores the first PN in a cache and places the first roaming request in a pending state.

At block 1415, the first AP retrieves one or more control-plane context parameters from a second AP (e.g., AP MLD 610-2 of FIG. 6) associated with the STA, the control-plane context parameters comprising a packet number (PN).

At block 1420, the first AP compares the first PN with the retrieved PN.

At block 1425, in response to determining that the first PN is less than or equal to the retrieved PN, the first AP transitions the first roaming request from the pending state to a discarded state.

In some embodiments, the first AP may receive a second roaming request from the STA, where the second roaming request comprises a second PN, store the second PN in the cache and place the second roaming request in a pending state, and compare the second PN with the retrieved PN. In response to determining that the first PN is greater than the retrieved PN, the first AP may transition the second roaming request from the pending state to an accepted state and send a roaming response to the STA to establish a connection.

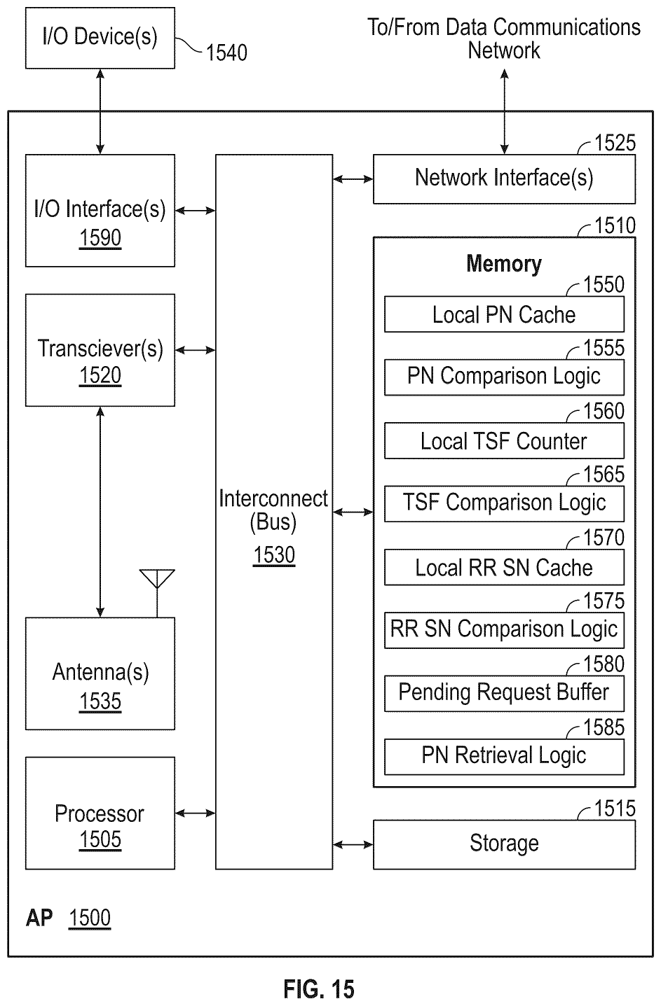

FIG. 15 depicts an example network device 1500 configured to perform various aspects of the present disclosure, according to some aspects of the present disclosure. The example network device 1500 may correspond to a serving AP or target AP within a SMD, as depicted in FIGS. 1-6.

As illustrated, the network device 1500 includes a processor 1505, memory 1510, storage 1515, one or more transceivers 1520, one or more I/O interfaces 1590, and one or more network interfaces 1525. In some embodiments, I/O devices 1540 are connected via the I/O interface(s) 1580. Further, via the network interface 1525, the network device 1500 can be communicatively coupled with one or more other devices and components (e.g., via a network, which may include the Internet, local network(s), and the like). Each of the components is communicatively coupled by one or more buses 1530. In some embodiments, one or more antennas 1535 may be coupled to the transceivers 1520 for transmitting and receiving wireless signals.

The processor 1505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1505 processes information received through the transceiver 1520, I/O interfaces 1590, and the network interfaces 1525. The processor 1505 retrieves and executes programming instructions stored in memory 1510, as well as stores and retrieves application data residing in storage 1515.

The storage 1515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1515 may store a variety of data for the efficient functioning of the system.

The memory 1510 may include random access memory (RAM) and read-only memory (ROM). The memory 1510 may store processor-executable software code containing instructions that, when executed by the processor 1505, enable the network device 1500 to perform various functions described herein for wireless communication.

When the network device 1500 operates to perform replay detection using cached PNs (as depicted in FIG. 3), the memory 1510 includes a local PN cache 1550 and a PN comparison logic 1555. The PN cache 1550 stores, for each STA MLD, the most recently accepted PN value extracted from roaming requests received at the network device 1500. The PN comparison logic 1555 is configured to extract the PN from an incoming roaming request (after decryption) and compares it with the cached PN value.

When the network device 1500 operates to perform TSF-based replay detection (as depicted in FIG. 4), the memory 1510 includes a local TSF counter 1560 and a TSF comparison logic 1565. The local TSF counter 1560 is configured to track the device's updating TSF value. The TSF comparison logic 1565 is configured to compare an estimated TSF value received from a STA with the current local TSF value. The TSF comparison logic 1565 computes the time delta between the two values and determines whether the request falls within a predefined validity window (e.g., based on threshold time offset).

When the network device 1500 operates to perform RR SN-based replay detection (as depicted in FIG. 5), the memory 1510 includes a local RR SN cache 1570 and a RR SN comparison logic 1575. The local RR SN cache 1570 is configured to store, for each STA, the last successfully accepted RR SN received from the roaming request. The RR SN comparison logic 1575 is configured to extract the RR SN from a newly received roaming request, compare it to the cached RR SN, and determine if the new value is greater than the stored value. If so, the request is classified as fresh (or new) and the cache is updated. If the RR SN is equal to or less than the cached value, the request is identified as stale (or replayed) and discarded without further processing.

When the network device 1500 operates to perform deferred PN-based replay detection (as depicted in FIG. 6), the memory 1510 includes a pending request buffer 1580, a PN retrieval logic 1585, and a PN comparison logic 1555. The pending request buffer 1580 temporarily stores decrypted roaming requests that are held pending PN validation. The PN retrieval logic 1585 is configured to initiate communication with the serving AP MLD to obtain the current PN state associated with the roaming STA. Once the PN state is received, the PN comparison logic 1555 compares the PN extracted from the pending roaming request against the PN state received from the serving AP. If the received PN is greater, the request is considered valid and further roaming procedures (e.g., context transfer) may proceed. Otherwise, the request is classified as a replay frame and discarded.

Although depicted as a discrete component for conceptual clarity, in some embodiments, the operations of the depicted components (and others not illustrated) may be combined or distributed across any number of components. Further, although depicted as software residing in memory 1510, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a first access point (AP), a first roaming request from a station (STA), wherein the first roaming request comprises a first packet number (PN); and
in response to determining that the first PN is less than or equal to a last known PN maintained by the first AP, discarding the roaming request by the first AP.

2. The method of claim 1, wherein the last known PN is determined by the first AP based on a prior roaming request successfully received and processed from the STA by the first AP.

3. The method of claim 1, wherein the last known PN is received from a second AP, wherein the first and second APs are within a same seamless mobility domain (SMD).

4. The method of claim 3, wherein the first roaming request is protected by a shared pairwise transient key (PTK) that is shared between the first AP and the second AP.

5. The method of claim 1, further comprising:
receiving, by the first AP, a second roaming request from the STA, wherein the second roaming request comprises a second PN; and
in response to determining that the second PN is greater than the last known PN, sending, by the first AP, a roaming response to the STA to establish a connection.

6. The method of claim 5, further comprising:
updating, by the first AP, the last known PN associated with the STA to reflect the second PN.

7. A method, comprising:
determining, by a first access point (AP), a threshold value based on one or more prior time synchronization function (TSF) offsets associated with a station (STA);
receiving, by the first AP, a roaming request from the STA, wherein the roaming request comprises an estimated TSF time of the first AP;
comparing, by the first AP, the estimated TSF time with a current TSF time maintained by the first AP; and
in response to determining that a difference between the estimated TSF time and the current TSF time exceeds the threshold value, discarding the roaming request by the first AP.

8. The method of claim 7, wherein the roaming request is protected by a shared pairwise transient key (PTK) that is shared between the first AP and a second AP, and the first and second APs are within a same seamless mobility domain (SMD).

9. The method of claim 7, further comprising:
receiving, by the first AP, a second roaming request from the STA, wherein the second roaming request comprises a second estimated TSF time of the first AP; and
comparing, by the first AP, the second estimated TSF time with the current TSF time maintained by the first AP.

10. The method of claim 9, further comprising:
in response to determining that a difference between the second estimated TSF time and the current TSF time is within the threshold value, sending, by the first AP, a roaming response to the STA to establish a connection.

11. The method of claim 9, further comprising:
in response to determining that a difference between the second estimated TSF time and the current TSF time is within the threshold value, retrieving, by the first AP, one or more control-plane context parameters from a second AP associated with the STA, the control-plane context parameters comprising a packet number (PN);
comparing a PN within the second roaming request with the retrieved PN; and
in response to determining that the PN within the second roaming request is greater than the retrieved PN, sending, by the first AP, a roaming response to the STA to establish a connection.

12. The method of claim 9, further comprising:
in response to determining that a difference between the second estimated TSF time and the current TSF time is within the threshold value, retrieving, by the first AP, one or more control-plane context parameters from a second AP associated with the STA, the control-plane context parameters comprising a packet number (PN);
comparing a PN within the second roaming request with the retrieved PN; and
in response to determining that the PN within the second roaming request is less than or equal to the retrieved PN, discarding the second roaming request by the first AP.

13. The method of claim 7, wherein the estimated TSF time of the first AP is determined by the STA based on a target beacon transmission time (TBTT) offset received in a reduced neighbor report (RNR) element.

14. The method of claim 13, wherein the RNR element is encapsulated within a beacon frame broadcast by the first AP or within a probe response frame sent by the first AP in response to a probe request from the STA.

15. A method, comprising:
receiving, by a first access point (AP), a first roaming request from a station (STA), wherein the roaming request comprises a first roaming request sequence number (RR SN) associated with the STA;
comparing, by the first AP, the first RR SN with a last known RR SN associated with the STA; and
in response to determining that the first RR SN is less than or equal to the last known RR SN, discarding the first roaming request by the first AP.

16. The method of claim 15, wherein the last known RR SN is determined by the first AP based on a prior roaming request successfully received and processed from the STA by the first AP.

17. The method of claim 15, wherein the last known RR SN is received from a second AP, wherein the first and second APs are within a same seamless mobility domain (SMD).

18. The method of claim 17, wherein the first roaming request is protected by a shared pairwise transient key (PTK) that is shared between the first AP and the second AP.

19. The method of claim 15, further comprising:
receiving, by the first AP, a second roaming request from the STA, wherein the second roaming request comprises a second RR SN; and
comparing, by the first AP, the second RR SN with the last known RR SN.

20. The method of claim 19, further comprising:
in response to determining that the second RR SN is greater than the last known RR SN, sending, by the first AP, a roaming response to the STA to establish a connection.

21. The method of claim 19, further comprising:
in response to determining that the second RR SN is greater than the last known RR SN, retrieving, by the first AP, one or more control-plane context parameters from a second AP associated with the STA, the control-plane context parameters comprising a packet number (PN);
comparing a PN within the second roaming request with the retrieved PN; and
in response to determining that the PN within the second roaming request is greater than the retrieved PN, sending, by the first AP, a roaming response to the STA to establish a connection.

22. The method of claim 19, further comprising:
in response to determining that the second RR SN is greater than the last known RR SN, retrieving, by the first AP, one or more control-plane context parameters from a second AP associated with the STA, the control-plane context parameters comprising a packet number (PN);
comparing a PN within the second roaming request with the retrieved PN; and
in response to determining that the PN within the second roaming request is less than or equal to the retrieved PN, discarding the second roaming request by the first AP.

23. A method, comprising:
receiving, by a first access point (AP), a first roaming request from a station (STA), wherein the first roaming request comprises a first PN;
storing, by the first AP, the first PN in a cache and placing the first roaming request in a pending state;
retrieving, by the first AP, one or more control-plane context parameters from a second AP associated with the STA, the control-plane context parameters comprising a packet number (PN);
comparing the first PN with the retrieved PN; and
in response to determining that the first PN is less than or equal to the retrieved PN, transitioning, by the first AP, the first roaming request from the pending state to a discarded state.

24. The method of claim 23, further comprising:
receiving, by the first AP, a second roaming request from the STA, wherein the second roaming request comprises a second PN;
storing, by the first AP, the second PN in the cache and placing the second roaming request in a pending state;
comparing the second PN with the retrieved PN; and
in response to determining that the first PN is greater than the retrieved PN, transitioning, by the first AP, the second roaming request from the pending state to an accepted state, and sending a roaming response to the STA to establish a connection.
